(19) United States
(12) Patent Application Publication
(10) Pub. No.: US 2024/0140471 A1
(43) Pub. Date: May 2, 2024

(54) VEHICLE

(71) Applicant: HONDA MOTOR CO., LTD., Tokyo (JP)

(72) Inventors: Satoshi SADAMURA, Tokyo (JP); Yugo KAJIWARA, Tokyo (JP)

(21) Appl. No.: 18/383,227

(22) Filed: Oct. 24, 2023

(30) Foreign Application Priority Data
Nov. 1, 2022 (JP) 2022-175649

(51) Int. Cl. B60W 50/16; B60W 30/18; G06V 20/58

(52) U.S. Cl. CPC B60W 50/16; B60W 30/18163; G06V 20/58; B60W 2050/0083

(57) ABSTRACT

The vehicle includes a direction indicator, an operation unit configured to receive an operation for changing a state of the direction indicator, a setting unit configured to set a feedback mode of the operation unit provided to a driver of the vehicle, and a detection unit configured to detect an obstacle included in a specific range around the vehicle. The setting unit is configured to set the feedback mode of the operation unit to a first feedback mode in a case where the obstacle is detected in the specific range, and set the feedback mode of the operation unit to a second feedback mode different from the first feedback mode in a case where the obstacle is not detected in the specific range.

### CROSS-REFERENCE TO RELATED APPLICATION(S)

This application claims priority to and the benefit of Japanese Patent Application No. 2022-175649, filed Nov. 1, 2022, the entire disclosure of which is incorporated herein by reference.

### BACKGROUND OF THE INVENTION

### Field of the Invention

The present invention relates to a vehicle.

### Description of the Related Art

Various techniques for improving safety when a driver of a vehicle changes a lane have been developed. Japanese Patent Laid-Open No. 2015-132966 describes that, when the fact that another vehicle approaches a predetermined range on a rear side is detected, a warning is issued to a driver by blinking a lamp and ringing a buzzer. When it is estimated that the driver is aware of a state of a road on the rear side, this warning is suppressed. When the lane change is performed, the driver uses an operation unit such as a blinker lever. Since the blinking of the lamp or the sound of the buzzer is provided at a position different from the operation unit such as the blinker lever, it may be difficult for the driver to intuitively grasp a surrounding situation of the vehicle.

### SUMMARY OF THE INVENTION

An aspect of the present disclosure provides a technique for allowing a driver to intuitively recognize a surrounding situation when lane change is performed. According to some embodiments, a vehicle is provided. The vehicle includes a direction indicator, an operation unit configured to receive an operation for changing a state of the direction indicator, a setting unit configured to set a feedback mode of the operation unit provided to a driver of the vehicle, and a detection unit configured to detect an obstacle included in a specific range around the vehicle. The setting unit is configured to set the feedback mode of the operation unit to a first feedback mode in a case where the obstacle is detected in the specific range, and set the feedback mode of the operation unit to a second feedback mode different from the first feedback mode in a case where the obstacle is not detected in the specific range.

### BRIEF DESCRIPTION OF THE DRAWINGS

FIG. 1 is a schematic diagram illustrating a configuration example of a vehicle according to some embodiments;

FIG. 2 is a schematic diagram illustrating a configuration example of a blinker lever according to some embodiments;

FIG. 3 is a schematic diagram for describing a situation of a vehicle to which some embodiments are applied;

FIG. 4 is a flowchart for describing an operation example of the vehicle according to some embodiments;

FIG. 5 is a diagram for describing an example of an indicator according to some embodiments;

FIG. 6 is a flowchart for describing an operation example of the vehicle according to some embodiments;

FIG. 7 is a diagram for describing a scenario to which some embodiments are applied; and

FIG. 8 is a diagram for describing another scenario to which some embodiments are applied.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

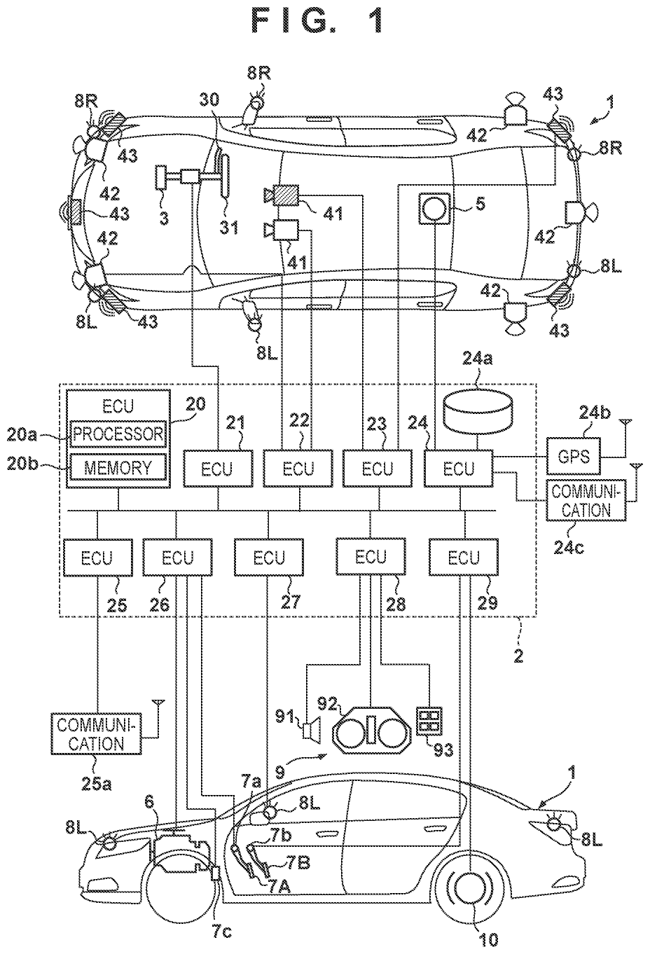

FIG. 1 is a block diagram of a vehicle 1 according to an embodiment of the present invention. In FIG. 1, the vehicle 1 is schematically illustrated in a plan view and in a side view. The vehicle 1 is, for example, a sedan-type four-wheeled passenger vehicle. The vehicle 1 may be such a four-wheeled vehicle, a two-wheeled vehicle, or any other types of vehicle. In the following description, a driver of the vehicle 1 is simply referred to as a driver.

The vehicle 1 includes a vehicle control device 2 (hereinafter, simply referred to as a control device 2) that controls the vehicle 1. The control device 2 includes a plurality of electronic control units (ECUs) 20 to 29 connected to be able to communicate with each other through an in-vehicle network. Each of the ECUs includes a processor represented by a central processing unit (CPU), a memory such as a semiconductor memory, an interface with an external device, and the like. The memory stores a program to be executed by the processor, data to be used for processing by the processor, and the like. Each of the ECUs may include a plurality of processors, memories, interfaces, and the like. For example, the ECU 20 includes a processor 20a and a memory 20b. The ECU 20 executes processing by the processor 20a executing a command included in the program stored in the memory 20b. Alternatively, the ECU 20 may include a dedicated integrated circuit such as an application specific integrated circuit (ASIC) or a field programmable gate array (FPGA) for causing the ECU 20 to execute processing. The same applies to other ECUs.

Hereinafter, functions and the like assigned to the ECUs 20 to 29 will be described. Note that the number of ECUs and functions assigned to the ECUs can be appropriately designed, and can be subdivided or integrated as compared with those in the present embodiment.

The ECU 20 executes control related to automated traveling of the vehicle 1. For automated driving, at least one of steering and acceleration or deceleration of the vehicle 1 is automatically controlled. The automated traveling by the ECU 20 may include automated traveling that does not require the driver to perform a traveling operation (which may also be referred to as automated driving) and automated traveling for assisting the driver in performing the traveling operation (which may also be referred to as driving assistance).

The ECU 21 controls an electric power steering device 3. The electric power steering device 3 includes a mechanism that steers front wheels in accordance with a driver's driving operation (steering operation) on a steering wheel 31. In addition, the electric power steering device 3 includes a motor that exerts a driving force for assisting the steering operation or automatically steering the front wheels, a sensor that detects a steering angle, and the like. When a driving state of the vehicle 1 is automated driving, the ECU 21 automatically controls the electric power steering device 3 in response to an instruction from the ECU 20 and controls a traveling direction of the vehicle 1.

The ECUs 22 and 23 control detection units 41 to 43 that detect a situation around the vehicle 1, and perform information processing on detection results. The detection units 41 are cameras that capture images in front of the vehicle 1 (which may also hereinafter be referred to as cameras 41), and are attached to a windshield on an interior side of the vehicle at the front of a roof of the vehicle 1 in the present embodiment. By analyzing the images captured by the cameras 41, it is possible to extract a contour of a target object or a lane division line (white line or the like) on a road.

The detection units 42 are light detection and rangings (LiDARs) (which may also hereinafter be referred to as LiDARs 42), and detect a target object around the vehicle 1, or measures a distance to the target object. In the present embodiment, five LiDARs 42 are provided, including one at each corner of a front portion of the vehicle 1, one at a center of a rear portion of the vehicle 1, and one on each lateral side of the rear portion of the vehicle 1. The detection units 43 are millimeter-wave radars (which may also hereinafter be referred to as radars 43), and detect a target object around the vehicle 1 or measure a distance to the target object. In the present embodiment, five radars 43 are provided, including one at the center of the front portion of the vehicle 1, one at each corner of the front portion of the vehicle 1, and one at each corner of the rear portion of the vehicle 1.

The ECU 22 controls one camera 41 and each LiDAR 42, and performs information processing on detection results. The ECU 23 controls the other camera 41 and each radar 43, and performs information processing on detection results. By providing two sets of devices for detecting a situation around the vehicle 1, the reliability of the detection results can be improved. By providing different types of detection units such as cameras, LiDARs, and radars, the surrounding environment of the vehicle 1 can be analyzed in multiple ways.

The ECU 24 controls a gyro sensor 5, a global navigation satellite system (GNSS) sensor 24b, and a communication device 24c, and performs information processing on detection results or communication results. The gyro sensor 5 detects a rotational movement of the vehicle 1. A track of the vehicle 1 can be determined based on a detection result of the gyro sensor 5, a wheel speed, and the like. The GNSS sensor 24b detects a current position of the vehicle 1. The communication device 24c performs wireless communication with a server that provides map information and traffic information to acquire such information therefrom. The ECU 24 can access a database 24a in which map information is stored, and the ECU 24 searches for a route from a current location to a destination. The ECU 24, the database 24a, and the GNSS sensor 24b constitute a so-called navigation device.

The ECU 25 includes a communication device 25a for inter-vehicle communication. The communication device 25a performs wireless communication with other surrounding vehicles to exchange information between the vehicles.

The ECU 26 controls a power plant 6. The power plant 6 is a mechanism that outputs a driving force for rotating driving wheels of the vehicle 1, and includes, for example, an engine and a transmission. For example, the ECU 26 controls an output of the engine according to a driver's driving operation (accelerator operation or acceleration operation) detected by an operation detection sensor 7a provided on an accelerator pedal 7A, or switches a gear ratio of the transmission based on information such as a vehicle speed detected by a vehicle speed sensor 7c. In a case where the driving state of the vehicle 1 is the automated driving, the ECU 26 automatically controls the power plant 6 in response to an instruction from the ECU 20, and controls the acceleration or deceleration of the vehicle 1.

The ECU 27 controls lighting devices (headlights, taillights, and the like) including direction indicators 8R and 8L. The direction indicator may also be referred to as a blinker. In the example of FIG. 1, the direction indicators 8R are provided at a right front portion, right door mirrors, and a right rear portion of the vehicle 1. The direction indicators 8L are provided at a left front portion, a left door mirror, and a left rear portion of the vehicle 1. In the following description, the direction indicators 8R and 8L are collectively referred to as the direction indicator 8. In the description of the present specification, a right side of the vehicle 1 means a right side with respect to a center of the vehicle as viewed from a rear side of the vehicle 1. A left side of the vehicle 1 means a left side with respect to the center of the vehicle as viewed from the rear side of the vehicle 1.

A blinker lever 30 is attached near the steering wheel 31. In the example of FIG. 1, the blinker lever 30 is attached to a right rear side of the steering wheel 31. Alternatively, the blinker lever 30 may be attached to a left rear side of the steering wheel 31. The ECU 27 detects that the blinker lever 30 is operated by the driver to change a state of the direction indicator 8. The ECU 27 changes the state (for example, turning off or blinking) of the direction indicator 8 according to the operation of the blinker lever 30 by the driver. In this manner, the blinker lever 30 functions as an operation unit that receives an operation for changing the state of the direction indicator 8. The blinker lever 30 is an example of such an operation unit. The operation for changing the state of the direction indicator 8 may be received by another mechanism, for example, a physical push button.

The ECU 28 controls an input and output device 9. The input and output device 9 outputs information to the driver, and receives information input from the driver. A voice output device 91 notifies the driver of information by voice. A display device 92 notifies the driver of information by displaying an image. The display device 92 is disposed, for example, in front of a driver's seat, and constitutes an instrument panel or the like. Note that, although the voice and the display have been given as examples here, information may also be notified by vibration or light. In addition, information may be notified by a combination of two or more of voice, display, vibration, and light. Furthermore, the combination or the mode of notification may be changed depending on the level (for example, a degree of urgency) of information to be notified. An input device 93 is a group of switches disposed at driver-operable positions to give an instruction to the vehicle 1, and may also include a voice input device.

The ECU 29 controls a brake device 10 and a parking brake (not illustrated). The brake device 10 is, for example, a disc brake device, and is provided on each wheel of the vehicle 1 to apply resistance against a rotation of the wheel to decelerate or stop the vehicle 1. The ECU 29 controls an operation of the brake device 10 in response to a driver's driving operation (braking operation) detected by an operation detection sensor 7b provided on a brake pedal 7B, for example. When a driving state of the vehicle 1 is automated driving, the ECU 29 automatically controls the brake device 10 in response to an instruction from the ECU 20 to control the vehicle 1 to be decelerated and stopped. The brake device 10 and the parking brake can also be operated to keep the vehicle 1 in the stopped state. In addition, when the transmission of the power plant 6 includes a parking lock mechanism, the parking lock mechanism can also be operated to maintain the stopped state of the vehicle 1.

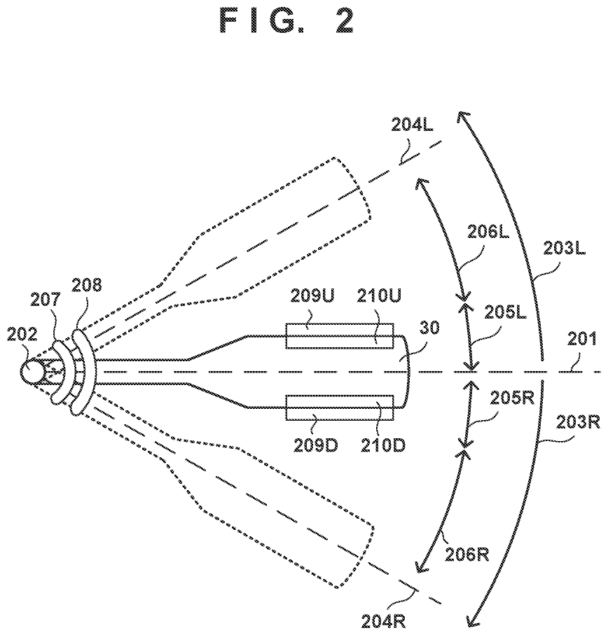

A configuration example of the blinker lever 30 will be described in detail with reference to FIG. 2. FIG. 2 illustrates a state where the blinker lever 30 is viewed from the driver. The blinker lever 30 is movable in each of a clockwise direction 203R about a shaft 202 and a counterclockwise direction 203L about the shaft 202. The blinker lever 30 may be further movable in a front direction and a back direction with respect to the driver.

The blinker lever 30 may be movable from a neutral position 201 to a termination position 204L in a counterclockwise direction 203L. The neutral position 201 is a position where the blinker lever 30 is placed when the driver does not perform an operation for changing the state of the direction indicator 8.

A non-detection range 205L and a detection range 206L are included between the neutral position 201 and the termination position 204L. The termination position 204L is included in the detection range 206L. The non-detection range 205L is positioned closer to the neutral position 201 than the detection range 206L. That is, an operation amount of the blinker lever 30 for moving the blinker lever 30 to the detection range 206L is larger than an operation amount of the blinker lever 30 for moving the blinker lever 30 to the non-detection range 205L.

The ECU 27 does not receive an operation for changing the state of the direction indicator 8 when the blinker lever 30 is positioned in the non-detection range 205L. Accordingly, when the blinker lever 30 is positioned in the non-detection range 205L, the ECU 27 maintains the state of the direction indicator 8 to a previous state. The non-detection range 205L functions as flexibility of the blinker lever 30. The ECU 27 receives the operation for changing the state of the direction indicator 8 when the blinker lever 30 is included in the detection range 206L. Specifically, the ECU 27 causes the direction indicator 8L to blink when the blinker lever 30 is positioned in the detection range 206L.

The vehicle 1 may have a biasing mechanism 207 that biases the blinker lever 30 toward the neutral position 201. The biasing mechanism 207 may include, for example, a spring or a motor. When the blinker lever 30 is positioned in the non-detection range 205L or the detection range 206L, the biasing mechanism 207 applies, to the blinker lever 30, a force for returning the blinker lever 30 to the neutral position 201. While moving the blinker lever 30, the driver receives a reaction force from the blinker lever 30. When the driver releases his or her hand from the blinker lever 30, the blinker lever 30 automatically returns to the neutral position 201.

The vehicle 1 may have a lock mechanism (not illustrated) that locks the blinker lever 30 to the termination position 204L. The lock mechanism fixes, to the termination position 204L, the blinker lever 30 moved to the termination position 204L. Even though the driver releases his or her hand from the blinker lever 30 at the termination position 204L, the blinker lever 30 is maintained at the termination position 204L. The fixation of the blinker lever 30 by the lock mechanism is canceled when a force equal to or greater than a threshold is applied to the blinker lever 30 toward the neutral position 201 by the driver or when the steering wheel 31 performs a predetermined operation.

The vehicle 1 may not have the above-described lock mechanism. In this case, when the driver releases his or her hand from the blinker lever 30 at the termination position 204L, the blinker lever 30 automatically returns to the neutral position 201. When the vehicle 1 does not have the lock mechanism, the ECU 27 may continue blinking the direction indicator 8L after the blinker lever 30 moves to the termination position 204L and then returns to the neutral position 201. The ECU 27 may end blinking of the direction indicator 8L (that is, turn off the direction indicator 8L) in response to the driver performing a predetermined operation (for example, movement of the blinker lever 30 to the detection range 206L or the detection range 206R).

The blinker lever 30 may be movable from the neutral position 201 to the termination position 204R in the clockwise direction 203R. The description of the termination position 204R, the non-detection range 205R, and the detection range 206R relates to the termination position 204L, the non-detection range 205L, and the detection range 206L except that the direction indicator 8R blinks instead of the direction indicator 8L. Thus, redundant description will be omitted.

The blinker lever 30 may be used not only to receive the operation for changing the state of the direction indicator 8 but also to receive an instruction to start a lane change to an automated driving function. For example, the automated driving function of the vehicle 1 may suggest the driver to change a lane to head for the destination. The driver may give the instruction to start the lane change to the automated driving function by using the blinker lever 30.

The vehicle 1 may have a use detection unit (for example, sensor) for detecting that the driver is using the blinker lever 30. The ECU 27 may determine whether or not the driver is using the blinker lever 30 based on an output from the use detection unit. When the ECU 27 determines that the driver is using the blinker lever 30 may vary depending on a configuration of the use detection unit. For example, the ECU 27 may determine that the driver is using the blinker lever 30 when the driver comes into contact with the blinker lever 30. The ECU 27 may determine that the driver is using the blinker lever 30 when the driver is pressing the blinker lever 30. The ECU 27 may determine that the driver is using the blinker lever 30 when the blinker lever 30 is not at the neutral position 201.

The use detection unit may include capacitance sensors 210U and 210D. The capacitance sensor 210U is disposed to cover an upper surface of the blinker lever 30. The capacitance sensor 210D is disposed to cover a lower surface of the blinker lever 30. When the driver performs an operation of moving the blinker lever 30 in the clockwise direction 203R (for example, when the direction indicator 8R is blinked), the driver typically comes into contact with the upper surface of the blinker lever 30. Thus, the ECU 27 may determine that the driver is using the blinker lever 30 to perform an operation of blinking the direction indicator 8R while the driver comes into contact with the capacitance sensor 210U. When the driver performs an operation of moving the blinker lever 30 in the counterclockwise direction 203L (for example, when the direction indicator 8L is blinked), the driver typically comes into contact with the lower surface of the blinker lever 30. Thus, the ECU 27 may determine that the driver is using the blinker lever 30 to perform an operation of blinking the direction indicator 8L while the driver comes into contact with the capacitance sensor 210D. The ECU 27 may determine that the driver is not using the blinker lever 30 while the driver does not come into contact with any of the capacitance sensors 210U and 210D.

The use detection unit may include a piezoelectric sensor instead of the above-described capacitance sensor. When the piezoelectric sensor is used, the pressing of the blinker lever 30 is detected instead of the contact with the blinker lever 30.

The use detection unit may include a position sensor 208 that detects a position of the blinker lever 30. The ECU 27 may determine that the driver is using the blinker lever 30 to perform the operation of blinking the direction indicator 8R while the position of the blinker lever 30 is in the clockwise direction 203R with respect to the neutral position 201. The ECU 27 may determine that the driver is using the blinker lever 30 to perform the operation of blinking the direction indicator 8L while the position of the blinker lever 30 is in the counterclockwise direction 203L with respect to the neutral position 201. The ECU 27 may determine that the driver is not using the blinker lever 30 while the position of the blinker lever 30 is at the neutral position 201.

The use detection unit may include any one of the above-described capacitance sensor, piezoelectric sensor, and position sensor, or any combination thereof.

The ECU 27 may be capable of setting a feedback modefeedback mode of the blinker lever 30 given to the driver. The blinker lever 30 provides feedback to the driver so that the driver can sense the feedback mode of the blinker lever 30. For example, the ECU 27 may be capable of setting the feedback mode of the blinker lever 30 to any of two or more feedback modes. The two or more feedback modes of the blinker lever 30 capable of being set by the ECU 27 may include a normal feedback mode and a warning feedback mode for attracting attention regarding the operation of the blinker lever 30. When the driver recognizes that the feedback mode of the blinker lever 30 is the warning feedback mode, the driver can recognize that attention is required for the operation of the blinker lever 30. For example, as will be described later, the ECU 27 may set the feedback mode of the blinker lever 30 to the warning feedback mode when an obstacle is detected on the rear side of the vehicle 1.

The vehicle 1 may have a vibration unit (for example, vibrator) for vibrating the blinker lever 30. The vibration unit may include, for example, piezoelectric elements 209U and 209D. The piezoelectric element 209U is disposed to cover the upper surface of the blinker lever 30. The piezoelectric element 209U vibrates the upper surface of the blinker lever 30. The piezoelectric element 209D is disposed to cover the lower surface of the blinker lever 30. The piezoelectric element 209D vibrates the lower surface of the blinker lever 30. Either the piezoelectric element 209U or the capacitance sensor 210U may be positioned on an outer side. The same applies to the piezoelectric element 209D and the capacitance sensor 210D.

The vibration unit may include a motor instead of the above-described piezoelectric element. The motor may vibrate the entire blinker lever 30. The vibration unit may include motors separately for the upper surface and the lower surface of the blinker lever 30, or may include one motor for the entire blinker lever 30.

The ECU 27 may set the feedback mode of the blinker lever 30 by setting a vibration level generated by the vibration unit. The ECU 27 may set the vibration level generated by the vibration unit to any of two levels (high level and low level). The vibration level may be defined by at least one of a cycle of vibration and an amplitude of vibration. For example, the high-level vibration may have a shorter cycle of vibration, a larger amplitude of vibration, or both the shorter cycle of vibration and the larger amplitude of vibration, as compared to the low-level vibration. The amplitude of the low-level vibration may be 0, and in this case, the vibration unit does not vibrate the blinker lever 30. When the feedback mode of the blinker lever 30 is set to the normal feedback mode, the ECU 27 may set the vibration level of the vibration unit to a low level. The driver may sense the normal feedback mode when the blinker lever 30 is not vibrating during the use of the blinker lever 30. When the feedback mode of the blinker lever 30 is set to the warning feedback mode, the ECU 27 may set the vibration level of the vibration unit to a high level. The driver may sense the warning feedback mode when the blinker lever 30 is vibrating during the use of the blinker lever 30.

The vibration level of the vibration unit of the blinker lever 30 may be set in accordance with the magnitude of a risk imposed on the vehicle 1 by the obstacle. For example, the ECU 27 may increase the vibration level of the vibration unit of the blinker lever 30 as the magnitude of the risk that the obstacle imposes on the vehicle 1 increases.

The ECU 27 may set the feedback mode of the blinker lever 30 by setting the force by which the biasing mechanism 207 biases the blinker lever 30. The force for biasing the blinker lever 30 may be defined by energy applied to the motor constituting the biasing mechanism 207. The force for biasing the blinker lever 30 may be defined by a configuration of a gear that connects the motor constituting the biasing mechanism 207 and the blinker lever 30.

The ECU 27 may set the force by which the biasing mechanism 207 biases the blinker lever 30 to any one of two levels (high level and low level). The high level has a stronger biasing force than the low level. When the feedback mode of the blinker lever 30 is set to the normal feedback mode, the ECU 27 may set the force generated by the biasing mechanism 207 to a low level. The driver may feel the normal feedback mode when a force for operating the blinker lever 30 is as usual. When the feedback mode of the blinker lever 30 is set to the warning feedback mode, the ECU 27 may set the force generated by the biasing mechanism 207 to a high level. The driver may sense the warning feedback mode when the force for operating the blinker lever 30 is stronger than usual (that is, it is difficult to move the blinker lever 30 more than usual).

The force generated by the biasing mechanism 207 may be set in accordance with the magnitude of the risk imposed on the vehicle 1 by the obstacle. For example, the ECU 27 may increase the force generated by the biasing mechanism 207 as the magnitude of the risk that the obstacle imposes on the vehicle 1 increases (that is, the blinker lever 30 may be made difficult to move).

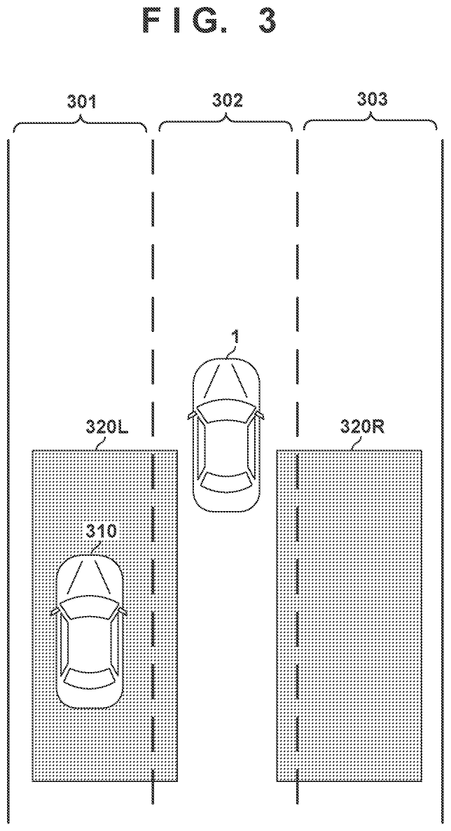

A situation in which the ECU 27 sets the feedback mode of the blinker lever 30 to the warning feedback mode will be described with reference to FIG. 3. It is assumed that the vehicle 1 is traveling in a lane 302 at a center of a road having three lanes 301 to 303. The detection units 43 detect an obstacle included in a specific range around the vehicle 1. In the example of FIG. 3, the detection unit 43 detects the obstacle included in one of a range 320R on the right side and the rear side of the vehicle 1 and a range 320L on the left side and the rear side of the vehicle 1. The obstacle to be detected is typically a vehicle other than the vehicle 1. In addition, the obstacle to be detected may include a fallen object on the road or the like.

First, a case where the driver of the vehicle 1 operates the blinker lever 30 to move the vehicle 1 to the lane 303 adjacent to a right side of the lane 302 (that is, change the lane) will be described. The lane change may be manually performed by the driver or may be performed by the automated driving function of the vehicle 1. The fact that the driver attempts to change the lane may be determined based on the fact that the driver is using the blinker lever 30 and there is an adjacent lane, or the like. The fact that a movement destination of the vehicle 1 is the right lane 303 may be determined based on the fact that the driver comes into contact with or presses the upper surface of the blinker lever 30 or the fact that the position of the blinker lever 30 is positioned in the clockwise direction 203R from the neutral position 201. Since the obstacle is not included in the range 320R, the control device 2 may not urge the driver to pay attention to the operation of the blinker lever 30. Thus, the ECU 27 sets the feedback mode of the blinker lever 30 to the normal feedback mode.

Next, a case where the driver of the vehicle 1 operates the blinker lever 30 to move the vehicle 1 to the lane 301 adjacent to the left side of the lane 302 (that is, change the lane) will be described. The lane change may be manually performed by the driver or may be performed by the automated driving function of the vehicle 1. The fact that the driver attempts to change the lane may be determined based on the fact that the driver is using the blinker lever 30 and there is an adjacent lane, or the like. The fact that the movement destination of the vehicle 1 is the left lane 301 may be determined based on the fact that the driver comes into contact with or presses the lower surface of the blinker lever 30 or the fact that the position of the blinker lever 30 is positioned in the counterclockwise direction 203L from the neutral position 201. Since the range 320R includes the obstacle (specifically, includes the vehicle 310), the control device 2 urges the driver to pay attention to the operation of the blinker lever 30. Thus, the ECU 27 sets the feedback mode of the blinker lever 30 to the warning feedback mode.

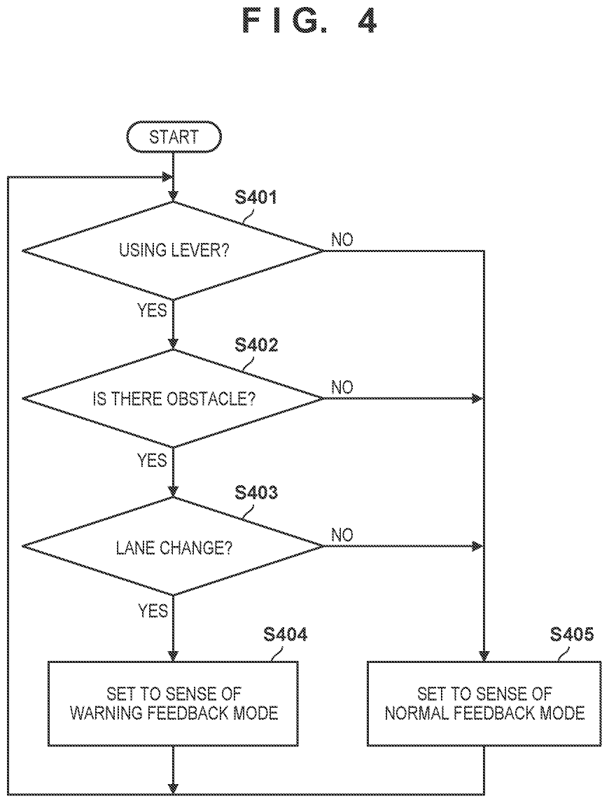

Next, an operation example executed by the control device 2 to set the feedback mode of the blinker lever 30 will be described with reference to FIG. 4. Each step of the method of FIG. 4 may be performed by a processor (for example, processor of the ECU 27) of the control device 2 executing a program read into a memory (for example, memory of the ECU 27) of the control device 2.

Alternatively, a part or all of the steps of the method of FIG. 4 may be performed by a dedicated circuit such as an application-specific integrated circuit (ASIC). The operation of FIG. 4 may be repeatedly executed while the vehicle 1 is traveling. An initial setting of the feedback mode of the blinker lever 30 may be the normal feedback mode. The setting of the feedback mode of the blinker lever 30 may be stored in a memory (for example, memory of the ECU 27) of the control device 2.

In S401, the control device 2 determines whether or not the driver is using the blinker lever 30. When it is determined that the driver is using the blinker lever 30 (“YES” in S401), the control device 2 shifts the processing to S402, and otherwise (“NO” in S401), the control device shifts the processing to S405. As described above, the determination in S401 may be performed based on the output from the use detection unit including the capacitance sensors 210U and 210D, the piezoelectric sensor, the position sensor 208, and the like.

In S402, the control device 2 determines whether or not the obstacle is detected in a specific range around the vehicle 1. When it is determined that the obstacle is detected in the specific range around the vehicle 1 (“YES” in S402), the control device 2 shifts the processing to S403, and otherwise (“NO” in S402), the control device shifts the processing to S405. As described above, the determination in S402 may be performed based on the output from the detection unit 43.

As described above, the specific range used in the determination in S402 may be a range on the side and the rear of the vehicle 1 (ranges 320L and 320R in FIG. 3). Alternatively, the specific range used in the determination in S402 may be a different range, for example, the entire side of the vehicle 1.

The control device 2 may individually perform the determination in S402 for each of the range on the right side and the rear side of the vehicle 1 (range 320R in FIG. 3) and the range on the left side and the rear side of the vehicle 1 (range 320L in FIG. 3). The control device 2 may determine YES in S402 when the driver attempts to move the vehicle 1 to the right adjacent lane (lane 303 in FIG. 3) and the obstacle is detected in the range 320R. The control device 2 may determine YES in S402 when the driver attempts to move the vehicle 1 to the left adjacent lane (lane 301 in FIG. 3) and the obstacle is detected in the range 320L. The control device 2 may determine NO in S402 when the driver attempts to move the vehicle 1 to the right adjacent lane (lane 303 in FIG. 3) and the obstacle is not detected in the range 320R. The control device 2 may determine NO in S402 when the driver attempts to move the vehicle 1 to the left adjacent lane (lane 301 in FIG. 3) and the obstacle is not detected in the range 320L.

In S403, the control device 2 determines whether or not the driver is using the blinker lever 30 to move the vehicle 1 to the adjacent lane. When it is determined that the driver is using the blinker lever 30 to move the vehicle 1 to the adjacent lane (“YES” in S403), the control device 2 shifts the processing to S404, and otherwise (“NO” in S403), the control device shifts the processing to S405. The determination in S403 may be performed based on whether or not there is an adjacent lane in a direction indicated by the direction indicator 8 by the driver. Alternatively or additionally, the determination in S403 may be performed based on a speed of the vehicle 1. For example, the control device 2 may determine that the driver is using the blinker lever 30 to move the vehicle 1 to the adjacent lane when the speed of the vehicle 1 is greater than a threshold (for example, 50 km/h) while the driver is using the blinker lever 30, and may determine that the driver is using the blinker lever 30 for a purpose other than moving the vehicle 1 to the adjacent lane in other cases.

When all the conditions used in the determinations in S401 to S403 are satisfied, the control device 2 sets the feedback mode of the blinker lever 30 to the warning feedback mode in S404. When at least one of the conditions used in the determinations in S401 to S403 is not satisfied, the control device 2 sets the feedback mode of the blinker lever 30 to the normal feedback mode in S405. In the method of FIG. 4, the determinations in S401 to S403 may be performed in any order.

According to the above method, the driver can recognize the surrounding situation of the vehicle 1 (specifically, whether or not the lane change can be safely performed) through the feedback mode of the operation unit (for example, blinker lever 30) that receives the operation for changing the state of the direction indicator 8. Thus, the driver can intuitively recognize the surrounding situation of the vehicle 1 when the lane change is performed. In addition, the driver can operate the blinker lever 30 in a series of flows after it is confirmed that the feedback mode of the blinker lever 30 is the normal feedback mode. Thus, an operation burden for the driver to change the lane is reduced. Furthermore, since the driver can recognize the surrounding situation of the vehicle 1 by tactile feedback, the driver can keep a line of sight directed in the traveling direction.

In S403, when the driver is using the blinker lever 30 to turn right or left at an intersection, for example, the control device 2 determines NO, and shifts the processing to S405. When the lane change is performed, the driver may wait while driving the vehicle 1 until there is no obstacle in the range 320L or 320R and the normal feedback mode of the blinker lever 30 is obtained. On the other hand, when the driver turns right or left at the intersection and there is the obstacle in the range 320L or 320R, the driver stops the vehicle 1 and waits, or drives the vehicle 1 while paying attention to the obstacle. Thus, when the feedback mode of the blinker lever 30 is set to the warning feedback mode in such a case, the driver may feel annoyed. Therefore, in some embodiments, when it is determined that the driver is using the blinker lever 30 for a purpose other than moving the vehicle 1 to the adjacent lane, the ECU 27 sets the feedback mode of the blinker lever 30 to the normal feedback mode.

The control device 2 performs the determination in S401, and thus, the setting of the feedback mode of the blinker lever 30 is maintained at the normal feedback mode while the driver is not using the blinker lever 30. As a result, unnecessary vibration of the blinker lever 30 and unnecessary increase of the force for biasing the blinker lever 30 are suppressed. Alternatively, in some embodiments, the determination in S401 may be omitted.

The control device 2 performs the determination in S403, and thus, the setting of the feedback mode of the blinker lever 30 is maintained in the normal feedback mode when the driver uses the blinker lever 30 without the purpose of the lane change. As a result, annoyance felt by the driver is reduced. Alternatively, in some embodiments, the determination in S401 may be omitted.

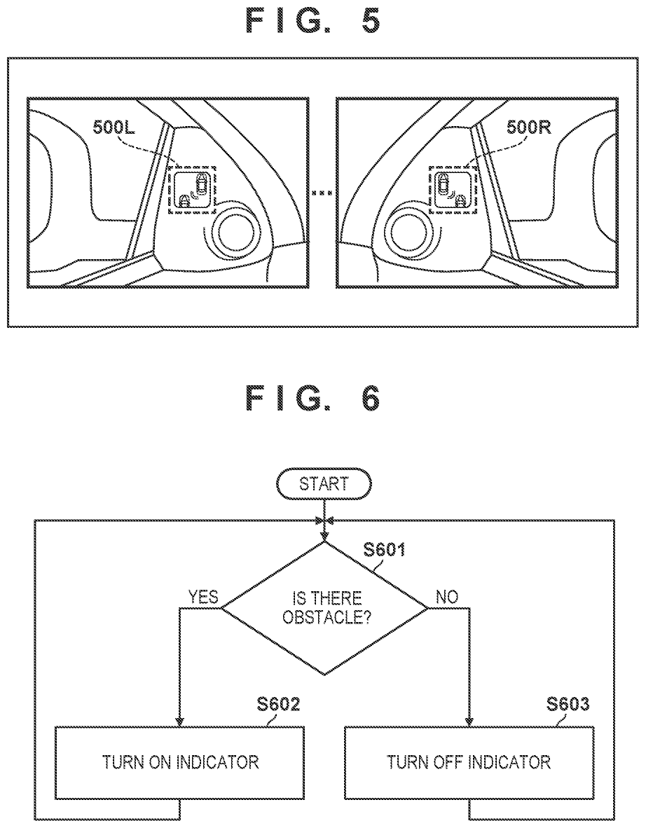

The vehicle 1 may further include a notification unit that visually notifies the driver that the obstacle is detected in a specific range (for example, range 320L or 320R) around the vehicle 1. Indicators 500L and 500R which are examples of such notification units will be described with reference to FIG. 5. In the following description, the indicators 500L and 500R are collectively referred to as an indicator 500. The indicator 500L visually notifies the driver that the obstacle is detected in the range 320L. The indicator 500L is disposed at a base of an A-pillar on the left side of the vehicle 1. The indicator 500 may be at another position, for example at the left door mirror. The control device 2 (for example, ECU 28) turns on the indicator 500L when the obstacle is detected in the range 320L, and turns off the indicator 500L when the obstacle is detected in the range 320L. A state where the indicator 500L is turned on may be a state where the indicator 500L is turned on or is blinking. A state where the indicator 500L is turned off may be a state where the indicator 500L is turned off. Since the description of the indicator 500R may be similar to the description of the indicator 500L except that the left and right are different, redundant description is omitted. The driver can recognize that the obstacle is detected in a specific range around the vehicle 1 by the indicator 500 as well as the feedback mode of the blinker lever 30.

Next, an operation example executed by the control device 2 to set a state of the indicator 500 will be described with reference to FIG. 6. Each step of the method of FIG. 6 may be performed by a processor (for example, processor of the ECU 28) of the control device 2 executing a program read into a memory (for example, memory of the ECU 28) of the control device 2. Alternatively, some or all of a plurality of steps in FIG. 6 may be performed by a dedicated circuit such as an ASIC. The operation of FIG. 6 may be repeatedly executed while the vehicle 1 is traveling.

In S601, the control device 2 determines whether or not the obstacle is detected in a specific range around the vehicle 1. When it is determined that the obstacle is detected in the specific range around the vehicle 1 (“YES” in S601), the control device 2 turns on the indicator 500 in S602. When it is determined that the obstacle is not detected in the specific range around the vehicle 1 (“NO” in S601), the control device 2 turns off the indicator 500 in S603.

A cycle of blinking while the indicator 500 is turned on may be the same as a vibration cycle of the vibration unit of the blinker lever 30. As a result, the driver can easily associate the vibration of the blinker lever 30 with the blinking of the indicator 500. Alternatively, the cycle of blinking while the indicator 500 is turned on may be different from the vibration cycle of the vibration unit of the blinker lever 30.

The voice output device 91 may function as a notification unit that aurally notifies the driver that the obstacle is detected in a specific range (for example, range 320L or 320R) around the vehicle 1. For example, the control device 2 may generate a warning sound from the voice output device 91 while the driver is using the blinker lever 30 in a state where the obstacle is detected in the range 320L or 320R.

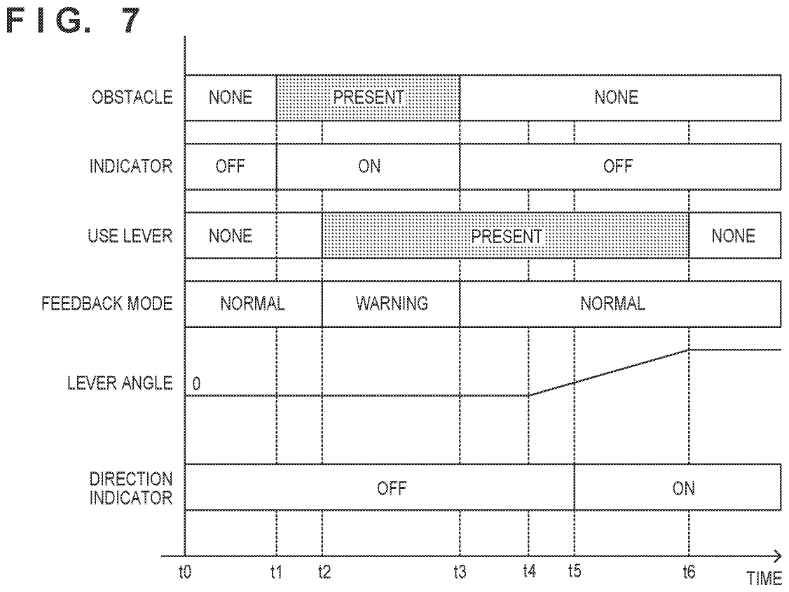

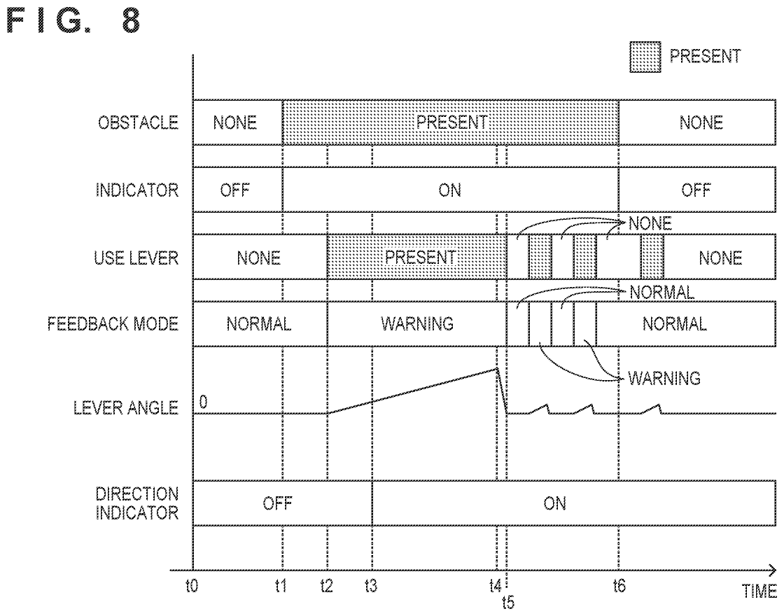

Scenarios to which the above-described embodiment is applied will be described with reference to FIGS. 7 and 8. In these scenarios, a case where the vehicle 1 performs the lane change to the left side is handled, but the same may be applied to a case where the vehicle 1 performs the lane change to the right side. In FIGS. 7 and 8, the “obstacle” indicates whether or not the obstacle is detected in the range 320L. “Absent” indicates that the obstacle is not detected, and “present” indicates that the obstacle is detected. “Indicator” indicates whether the indicator 500L is turned “on” or “off”. “Use lever” indicates whether or not the driver is using the blinker lever 30 to move the vehicle 1 to the lane adjacent to the left side. “Present” indicates that the blinker lever 30 is in use in this manner, and “absent” indicates that the blinker lever 30 is not in use for such a purpose. “Feedback mode” indicates whether the feedback mode of the blinker lever 30 is the normal feedback mode (“normal” in the drawing) or the warning feedback mode (“warning” in the drawing). “Lever angle” indicates the operation amount of the blinker lever 30. When the blinker lever 30 is at the neutral position 201, the operation amount is 0. The counterclockwise direction 203L is defined as a positive operation amount. “Direction indicator” indicates whether the direction indicator 8L is turned “on” (that is, blinking state) or “off” (that is, turned-off state).

In the example of FIG. 7, a case where the vehicle 1 includes the lock mechanism of the blinker lever 30, the use detection unit includes the capacitance sensors 210U and 210D, and the feedback mode of the blinker lever 30 is set by the vibration unit will be described.

It is assumed that the obstacle is not detected in the range 320L at time t0 and the driver is not using the blinker lever 30. Thus, the control device 2 turns off the indicator 500L, turns off the direction indicator 8L, and sets the feedback mode of the blinker lever 30 to the normal feedback mode. In addition, since the driver is not using the blinker lever 30, the lever angle is 0.

At time t1, the obstacle is detected in the range 320L. This obstacle remains in the range 320L until time t3 to be described later. Since the obstacle is detected in the range 320L, the control device 2 turns on the indicator 500L.

At time t2, the driver starts using the blinker lever 30 to move the vehicle 1 to the lane adjacent to the left side. Specifically, the driver comes into contact with the lower surface of the blinker lever 30. Since the driver comes into contact with only the blinker lever 30, the lever angle remains 0. Since all the conditions of S401 to S403 in FIG. 4 are satisfied, the control device 2 sets the feedback mode of the blinker lever 30 to the warning feedback mode. Since the feedback mode of the blinker lever 30 is different from usual (that is, is the warning feedback mode), the driver waits while coming into contact with the lower surface of the blinker lever 30 without operating the blinker lever 30.

At time t3, the obstacle in the range 320L disappears from the range 320L. Accordingly, the control device 2 turns off the indicator 500L. In addition, since the condition of S402 in FIG. 4 is not satisfied, the control device 2 sets the feedback mode of the blinker lever 30 to the normal feedback mode.

Since an operational feeling of the blinker lever 30 returns to be as usual (that is, becomes the normal feedback mode), the driver starts the operation of the blinker lever 30. Since the position of the blinker lever 30 is included in the non-detection range 205L from time t4 to time t5, the control device 2 maintains the direction indicator 8L in the turned-off state. When the position of the blinker lever 30 reaches the detection range 206L at time t5, the control device 2 turns on the direction indicator 8L.

When the blinker lever 30 is fixed to the termination position 204L at time t6, the driver releases his or her hand from the blinker lever 30. Thus, the control device 2 determines that the driver is not using the blinker lever 30. Thereafter, the driver confirms safety by visually observing the range 320L, and then moves the vehicle 1 to the lane 301.

In the example of FIG. 8, a case where the vehicle 1 does not include the lock mechanism of the blinker lever 30, the use detection unit includes the position sensor 208, and the feedback mode of the blinker lever 30 is set by the biasing force of the biasing mechanism 207 will be described.

The processing up to time t2 is similar to the processing in the example of FIG. 7. At time t2, the driver starts the operation of moving the blinker lever 30 in the counterclockwise direction 203L in order to indicate to the surrounding vehicles that the driver desires to change the lane to the left. Accordingly, since all the conditions of S401 to S403 in FIG. 4 are satisfied, the control device 2 sets the feedback mode of the blinker lever 30 to the warning feedback mode. The driver recognizes that the feedback mode of the blinker lever 30 is different from usual (that is, is the warning feedback mode), but continues the operation of the blinker lever 30.

Since the position of the blinker lever 30 is included in the non-detection range 205L from time t2 to time t3, the control device 2 maintains the direction indicator 8L in the turned-off state. When the position of the blinker lever 30 reaches the detection range 206L at time t3, the control device 2 turns on the direction indicator 8L.

At time t4, the driver moves the blinker lever 30 to the termination position 204L and then releases his or her hand. Since the blinker lever 30 is not fixed, the blinker lever returns to the neutral position 201 at time t5. As a result, since the control device 2 does not satisfy the condition of S401 in FIG. 4, the control device 2 sets the feedback mode of the blinker lever 30 to the normal feedback mode.

After time t4, the driver repeatedly moves the blinker lever 30 to confirm the situation of the range 320L. Whenever the driver moves the blinker lever 30, the control device 2 sets the feedback mode of the blinker lever 30 to the warning feedback mode.

At time t5, the obstacle in the range 320L disappears from the range 320L. Accordingly, the control device 2 turns off the indicator 500L. After time t5, the driver moves the blinker lever 30 to confirm the situation of the range 320L. Since the condition of S402 in FIG. 4 is not satisfied, the control device 2 sets the feedback mode of the blinker lever 30 to the normal feedback mode. As a result, the driver can recognize that the obstacle in the range 320L is no longer detected in the range 320L. Therefore, the driver moves the vehicle 1 to the lane 301 after confirming the safety by visually observing the range 320L.

### SUMMARY OF EMBODIMENTS

[Item 1]

A vehicle (1) comprising:

a direction indicator (8L, 8R);

an operation unit (30) configured to receive an operation for changing a state of the direction indicator;

a setting unit (27) configured to set a feedback mode of the operation unit provided to a driver of the vehicle; and

a detection unit (43) configured to detect an obstacle (310) included in a specific range (320L, 320R) around the vehicle,

wherein the setting unit is configured to
set the feedback mode of the operation unit to a first feedback mode in a case where the obstacle is detected in the specific range, and
set the feedback mode of the operation unit to a second feedback mode different from the first feedback mode in a case where the obstacle is not detected in the specific range.

According to this item, the driver can intuitively recognize the surrounding situation when the lane change is performed.

[Item 2]

The vehicle according to Item 1,

wherein the specific range is a range on a side or a rear of the vehicle, and

the setting unit is configured to set the feedback mode of the operation unit to the first feedback mode in a case where the obstacle is detected in the specific range and the driver is using the operation unit in order to move the vehicle to an adjacent lane.

According to this item, the unnecessary change in the feedback mode of the operation unit is suppressed.

[Item 3]

The vehicle according to Item 1, further comprising:

a vibration unit (209U, 209D) configured to vibrate the operation unit,

wherein, in a case where the feedback mode of the operation unit is set to the first feedback mode, a cycle of vibration of the operation unit is shorter or an amplitude of the vibration of the operation unit is larger compared to a case where the feedback mode of the operation unit is set to the second feedback mode.

According to this item, the driver can recognize that the obstacle is detected in the specific range by the vibration of the operation unit.

[Item 4]

The vehicle according to Item 1, further comprising:

a biasing unit (207) configured to bias the operation unit toward a neutral position,

wherein, in a case where the feedback mode of the operation unit is set to the first feedback mode, a magnitude of a force for moving the operation unit is larger compared to a case where the feedback mode of the operation unit is set to the second feedback mode.

According to this item, the driver can recognize that the obstacle is detected in the specific range by the ease of movement of the operation unit. [Item 5]

The vehicle according to Item 1, further comprising: a notification unit (500L, 500R) configured to visually notify the driver that the obstacle is detected in the specific range.

According to this item, the driver can visually recognize that the obstacle is detected in the specific range.

[Item 6]

The vehicle according to Item 1,

wherein, in a case where an operation amount of the operation unit is included in a first range, the setting unit is configured to set the feedback mode of the operation unit to the second feedback mode and not to receive an operation for changing a state of the direction indicator, and

in a case where the operation amount of the operation unit is included in a second range larger than the first range, the setting unit is configured to set the feedback mode of the operation unit to the second feedback mode, and receive an operation for changing the state of the direction indicator.

According to this item, the direction indicator is suppressed from being excessively turned on.

The invention is not limited to the foregoing embodiments, and various variations/changes are possible within the spirit of the invention.

What is claimed is:

1. A vehicle comprising:
a direction indicator;
an operation unit configured to receive an operation for changing a state of the direction indicator;
a setting unit configured to set a feedback mode of the operation unit provided to a driver of the vehicle; and
a detection unit configured to detect an obstacle included in a specific range around the vehicle,
wherein the setting unit is configured to
set the feedback mode of the operation unit to a first feedback mode in a case where the obstacle is detected in the specific range, and
set the feedback mode of the operation unit to a second feedback mode different from the first feedback mode in a case where the obstacle is not detected in the specific range.

2. The vehicle according to claim 1,
wherein the specific range is a range on a side or a rear of the vehicle, and
the setting unit is configured to set the feedback mode of the operation unit to the first feedback mode in a case where the obstacle is detected in the specific range and the driver is using the operation unit in order to move the vehicle to an adjacent lane.

3. The vehicle according to claim 1, further comprising:
a vibration unit configured to vibrate the operation unit,
wherein, in a case where the feedback mode of the operation unit is set to the first feedback mode, a cycle of vibration of the operation unit is shorter or an amplitude of the vibration of the operation unit is larger compared to a case where the feedback mode of the operation unit is set to the second feedback mode.

4. The vehicle according to claim 1, further comprising:
a biasing unit configured to bias the operation unit toward a neutral position,
wherein, in a case where the feedback mode of the operation unit is set to the first feedback mode, a magnitude of a force for moving the operation unit is larger compared to a case where the feedback mode of the operation unit is set to the second feedback mode.

5. The vehicle according to claim 1, further comprising: a notification unit configured to visually notify the driver that the obstacle is detected in the specific range.

6. The vehicle according to claim 1,
wherein, in a case where an operation amount of the operation unit is included in a first range, the setting unit is configured to set the feedback mode of the operation unit to the second feedback mode and not to receive an operation for changing a state of the direction indicator, and
in a case where the operation amount of the operation unit is included in a second range larger than the first range, the setting unit is configured to set the feedback mode of the operation unit to the second feedback mode, and receive an operation for changing the state of the direction indicator.
